(19) United States
(12) Patent Application Publication
(10) Pub. No.: US 2020/0011416 A1
(43) Pub. Date: Jan. 9, 2020

(54) METHOD FOR OPERATING A HYDROSTATIC TRANSMISSION OF A DRIVE TRAIN OF A MOTOR VEHICLE

(71) Applicant: ZF Friedrichshafen AG, Friedrichshafen (DE)

(72) Inventors: Marcus HIEMER, Meckenbeuren (DE); Martin LAUPHEIMER, Ravensburg (DE); Jan-Frederik KUHN, Friedrichshafen (DE)

(21) Appl. No.: 16/490,363

(22) PCT Filed: Feb. 7, 2018
(86) PCT No.: PCT/EP2018/053008

§ 371 Date: Aug. 30, 2019

(30) Foreign Application Priority Data
Mar. 3, 2017 (DE) 10 2017 203 544.7

(51) Int. Cl. F16H 61/47; B60W 30/18; F16H 59/18; F16H 59/44; F16H 59/54; F16H 61/433; F16H 59/68

(52) U.S. Cl. CPC F16H 61/47; B60W 30/18063; F16H 59/18; F16H 59/44; F16H 2312/06; F16H 61/433; F16H 59/68; F16H 2059/6853; F16H 59/54

(57) ABSTRACT

A method for operating a hydrostatic transmission of a drive train of a motor vehicle. An automatic creep function of the motor vehicle is made possible by the hydrostatic transmission. in order to be able to realize the creep function in a reliable manner, a current value of a first parameter that is independent of a pedal position of an accelerator and a current value of a second parameter that is dependent on the pedal position are compared to each another. The creep function is then activated as long as the current value of the first parameter is greater than the current value of the second parameter. In the context of the creep function, the current value of the first parameter is used to determine a current value of a target delivery quantity of a hydrostatic machine of the transmission operated as a pump.

This application is a National Stage completion of PCT/EP2018/1053008 filed Feb. 7, 2018, which claims priority from German patent application serial no. 10 2017 203 544.7 filed Mar. 3, 2017.

### BACKGROUND OF THE INVENTION

The invention relates to a method for operating a hydrostatic transmission of a drive train of a motor vehicle, wherein an automatic creep function of the motor vehicle is made possible by means of the hydrostatic transmission. The invention furthermore relates to a control unit for a hydrostatic transmission, to a computer program product and to a data carrier having a computer program product.

### BACKGROUND OF THE INVENTION

In motor vehicles with hydrodynamic torque converters, drive movement is transmitted from a main engine of the motor vehicle to the drive axle or drive axles of the motor vehicle due to the properties of the hydrodynamic torque converter, even if an accelerator is not actuated. If simultaneous actuation of a service brake of the motor vehicle concerned does not occur, the consequence is an automatic, extremely slow movement of the motor vehicle, wherein this movement, which is also known as creeping, is advantageous if, for example, the vehicle has to be started from a stationary state on a slope without rolling backwards. In some commercial vehicles such as mobile working machines or also farm tractors, it may also be desirable to move the vehicle at very low speeds in the context of a creep function for performing certain tasks. Although this creep function is provided in a drive train having a hydrodynamic torque converter, additional measures are required for drive trains lacking hydrodynamic torque converters. Among other things, realizing a creep function by means of the hydrostatic transmission is thus known in the case of a drive train having a hydrostatic transmission.

A method for operating a hydrostatic transmission is thus known from DE 102 51 939 A1, in which a creep function is automatically enabled by means of the hydrostatic transmission. Specifically, torque on the hydrostatic transmission is increased when the vehicle is in a stationary state if the existence of a neutral position is detected in a mechanical transmission of the motor vehicle, a starting element in the form of a frictional clutch is open, a service brake of the motor vehicle is not actuated, and an accelerator is also not actuated by the driver. Increasing the torque initiates a creeping of the motor vehicle.

### SUMMARY OF THE INVENTION

On the basis of the prior art described above, the problem addressed by the invention is that of realizing a method for operating a hydrostatic transmission, wherein it should be possible to enable a creep function of the motor vehicle automatically and in a reliable manner in the context of this method.

From a procedural standpoint, this problem is solved on the basis of the independent claim(s). In addition, a control unit, by means of which an aforementioned method can be realized, is the subject matter of the independent claim(s). The respective dependent claims that follow each disclose advantageous further developments of the invention. Lastly, a computer program product for a control unit and a data carrier having such a computer program products are claimed in the independent claim(s).

According to the invention, with a method for operating a hydrostatic transmission of a drive train, an automatic creep function of the motor vehicle is made possible by means of the hydrostatic transmission. According to the invention, the hydrostatic transmission is thus used for enabling an automatic creep function of the vehicle concerned, i.e., for automatically making very slow movement of the motor vehicle possible, even without actuation of an accelerator.

Within the meaning of the invention, in a manner fundamentally known to persons skilled in the art, a hydrostatic transmission is composed of two hydrostatic machines that are interconnected to one another in a hydraulic circuit. During operation of the hydrostatic transmission, one of the hydrostatic machines is operated as a hydraulic pump and the other hydrostatic machine is operated as a hydraulic motor, wherein the machine operating as a pump in the driven state delivers a quantity of fluid corresponding to its delivery quantity, which is supplied to the machine operated as a hydraulic motor, thereby generating movement on the part of this machine. It is possible to change the delivery quantity in the machine operating as a pump, wherein particular preference is given to the respective delivery or displacement volumes being variable in both hydrostatic machines. More preferably, both hydrostatic machines can be operated either as a pump or as a motor. The hydrostatic machines are in particular axial piston machines, wherein the individual axial piston machine can be designed as a bent-axis machine, a swash plate machine, or as a wobble plate machine. A change in the individual delivery or displacement volume can be brought about in particular by changing an individual swivel angle of the machine.

A hydrostatic transmission as mentioned above is in particular provided in a drive train of a motor vehicle and is preferably part of a power-split transmission. In the latter case, the hydrostatic transmission is then provided in parallel with a mechanical transmission, the latter being in particular a stepped transmission in the form of a spur gear or planetary gear transmission, for example. A branching into the power paths to the hydrostatic transmission and to the mechanical transmission, or also a merging of the power paths then takes place with further preference at a summation stage, which in particular is designed as a planetary stage. A motor vehicle having a drive train as mentioned above is in particular a commercial vehicle such as a mobile work machine.

The invention comprises the technical teaching that a current value of a first parameter that is independent of a pedal position of an accelerator and a current value of a second parameter that is dependent on the pedal position are compared to each another. The creep function is activated as long as the current value of the first parameter is greater than the current value of the second parameter. In the context of the creep function, the current value of the first parameter is then used to determine a current value of a target delivery quantity of the hydrostatic machine operated as a pump.

In other words, in the context of the method according to the invention, current values of two parameters are compared to each another, wherein the first parameter is independent of a pedal position of an accelerator of the motor vehicle, whereas the second parameter is dependent on the pedal position of the accelerator. The creep function is then active if the current value of the first parameter is greater than the current value of the second parameter, wherein a target delivery quantity of the pump of the hydrostatic transmission is determined on the basis of the current value of the first parameter in the context of the creep function.

Such an embodiment of the method has the advantage that by activating a creep function as a function of the relationship of a parameter that is dependent on a pedal position of the accelerator to a parameter that is independent of the pedal position, it is possible to reproduce the behavior of a drive train having a hydrodynamic torque converter. This is so because very slight or even no actuation of an accelerator results in a corresponding low value of the second parameter, which is then less than the value of the first parameter that is not dependent on the pedal position. Because a target delivery quantity of the pump of the hydrostatic transmission is then also determined in the context of the creep function on the basis of the current value of the first parameter, creep movement of the motor vehicle can be realized independently of the pedal position, as in this case a transmission ratio that is independent of the accelerator position is automatically set in the hydrostatic transmission.

In the present case, a suitable arrangement for activating the creep function can be designed by comparing the two parameters. However, if a requirement is made by the driver via the accelerator, a standard operation of the hydrostatic transmission, in which the target delivery quantity is set as a function of the current value of the second parameter, takes place apart from the creep function.

In the case of DE 102 51 939 A1 as well, the creep function becomes active if the accelerator is not actuated and if additional conditions in the form of non-actuation of the service brake, an open frictional clutch and a neutral position in the mechanical transmission prevail. However, the nature of the regulation of the hydrostatic machine in the context of the creep function is not described in any further detail in DE 102 51 939 A1.

As “pedal position of the accelerator pedal” according to the invention preferably a pedal position of the accelerator pedal is included in percent, which was determined based on a pedal angle of the accelerator pedal. Alternatively, the pedal position can also be represented directly by the pedal angle. The pedal angle can be measured directly via sensors or be determined from a different parameter, such as a pedal path.

Whereas the second parameter is dependent on the pedal position of the accelerator, the first parameter is independent of the pedal position. The first parameter particularly preferably depends on one or more other parameters of the motor vehicle. However, the first parameter can also be designed as a constant in the simplest case, in other words it is not dependent on any other quantity and has a constant value. The target delivery quantity of the hydrostatic machine is then set according to the constant value of the first parameter, even in the event of non-actuation or insufficient actuation of the accelerator.

Alternatively, in an advantageous embodiment of the invention, the first parameter is dependent on a driving speed of the motor vehicle. The advantage of this is that a suitable transition from normal operation of the motor vehicle to creeping can be realized by the dependency of the first parameter on the driving speed. The driving speed can either be used directly to determine the current value of the first parameter, or the latter is achieved indirectly by means of a quantity correlated with the driving speed, the quantity preferably being an output speed of the transmission, as the output speed of the transmission is typically closely linked to the driving speed of the motor vehicle.

In a further development of the aforementioned embodiment, a progression of the first parameter is on a declining scale with respect to the driving speed. Accordingly, as the driving speed increases, the corresponding value of the first parameter decreases, whereby a suitable transition to the creep movement of the motor vehicle is achievable. In the case of a coasting vehicle and non-actuation of the accelerator, the driving speed progressively decreases. In the context of the creep function and due to the increasing value of the first parameter, the value for the target delivery quantity therefore also increases such that the motor vehicle progressively transitions to the creep movement.

According to a further alternative or also supplementary further development of the embodiment, the driving speed is taken into account with a sign attributed thereto, wherein different progressions of the first parameter are specified for positive and for negative values of the driving speed. The advantage of this is that a different creeping behavior is achievable for the forward travel and for the reverse travel of the motor vehicle. Thus, in contrast to a drive train having a hydrodynamic torque converter, different creeping characteristics of the motor vehicle can be realized for forward and reverse travel of the motor vehicle.

According to a further design option of the invention, a progression of the first parameter can be changed by a driver of the vehicle. The driver of the vehicle is thus able to modify the progression of the first parameter, this being possible in particular when a parallel shift of the progression towards larger or also towards smaller values can be undertaken. As a result, the driver also has the option of varying the ultimate speed of the motor vehicle that is set in the context of the creep function. Optionally, it is also possible to create an opportunity for further change of the progression of the first parameter in lieu of a parallel shift. In particular, the driver of the vehicle can make a change by means of a corresponding control element.

In a further development of the invention, an actuation state of a service brake is taken into account, wherein a progression of the first parameter is changed when the service brake is actuated. The progression of the first parameter is particularly preferably shifted in parallel towards smaller values when the service brake is actuated such that, in the context of the creep function, smaller creep movements of the vehicle are set and the vehicle creeps to a lesser extent against the actuated service brake. Further preference is given to setting the current value of the first parameter to zero when a defined actuation level of the service brake is surpassed. Above this actuation level of the service brake, the motor vehicle can thus be brought to a stop, and it is simultaneously possible to minimize losses that would otherwise occur due to the main engine counteracting the service brake.

According to a further embodiment of the invention, a nominal swivel angle of the hydrostatic machine that is independent of the pedal position of the accelerator is taken into account as the first parameter and a nominal swivel angle of the hydrostatic machine that is dependent on the pedal position of the accelerator is taken into account as the second parameter, wherein a value of a resulting nominal swivel angle of the hydrostatic machine is set equal to the larger current value of the two parameters. In this case, the values of two parameters in the form of nominal swivel angles of the hydrostatic machine are thus compared to each another in the context of the method according to the invention, wherein one of the nominal swivel angles is dependent on the pedal position of the accelerator, whereas the other nominal swivel angle is not dependent thereon. Ultimately, the larger value of the two nominal swivel angles is used as the value for the nominal swivel angle to be specified for the hydrostatic machine.

According to an alternative design option of the invention, a hypothetical pedal position of the accelerator is taken into account as a first parameter and an actual pedal position of the accelerator is taken into account as a second parameter, wherein the larger current value of the two parameters is used to determine a current value of a nominal swivel angle in the context of the creep function. In contrast to the variant described above, in this case a nominal swivel angle of the hydrostatic machine is always determined as a function of the accelerator, wherein in the case of active creep function, however, the system specifies a hypothetical value differing from the actual pedal position such that a corresponding value for the nominal swivel angle also arises therefrom. Thus, the nominal swivel angle is determined either from the actual pedal position in normal operation or from the hypothetical pedal position in the context of the creep function.

The subject matter of the invention is also a control unit for a hydrostatic transmission, which comprises a device for regulating a delivery volume of a hydrostatic machine of the transmission operating as a pump. The device is configured to compare to each other a current value of a first parameter that is independent of a pedal position of an accelerator of a motor vehicle and a current value of a second parameter that is dependent on the pedal position and to use the larger of the two current values for determining a current value of target delivery quantity of the hydrostatic machine. The control unit is particularly preferably the transmission control unit, by means of which the hydrostatic transmission or, in the case of a power-split transmission, also the mechanical transmission, is controlled. Within the motor vehicle, this control unit is then integrated in a data bus system, via which it communicates with other control units in order to obtain, among other things, information on the current accelerator position.

The solution according to the invention can also be embodied as a computer program product that, when executed on a processor of a control unit, prompts the processor, via software, to carry out the assigned method steps that are the subject matter of the invention. In this context, a computer-readable medium, on which a computer program product as described above is retrievably stored, is also the subject matter of the invention.

The invention is not limited to the stated combination of features of the independent claims or the claims dependent thereon. Further possibilities arise for combining individual features with one another, provided that the latter also arise from the claims, the following description of preferred embodiments of the invention, or directly from the drawings. The references of the claims to the drawings, which are expressed using reference signs, shall not be construed as limiting the scope of protection of the claims.

### BRIEF DESCRIPTION OF THE DRAWINGS

Advantageous embodiments of the invention, which shall be explained in the following, are illustrated in the drawings. Shown in:

FIG. 1 is a schematic view of a drive train of a motor vehicle;

FIG. 2 is a flow diagram of a method for operating a hydrostatic transmission of the drive train from FIG. 1, according to a first embodiment of the invention;

FIG. 3 is an illustrative diagram of a parameter of the method from FIG. 2;

FIG. 4 is an illustrative diagram of a parameter of the method from FIG. 2;

FIG. 5 is a flow diagram of a method for operating a hydrostatic transmission of the drive train from FIG. 1, according to a second design option of the invention;

FIG. 6 is an illustrative diagram of a parameter of the method from FIG. 5; and

FIG. 7 is an illustrative diagram of a parameter of the method from FIG. 5.

### DETAILED DESCRIPTION OF THE PREFERRED EMBODIMENTS

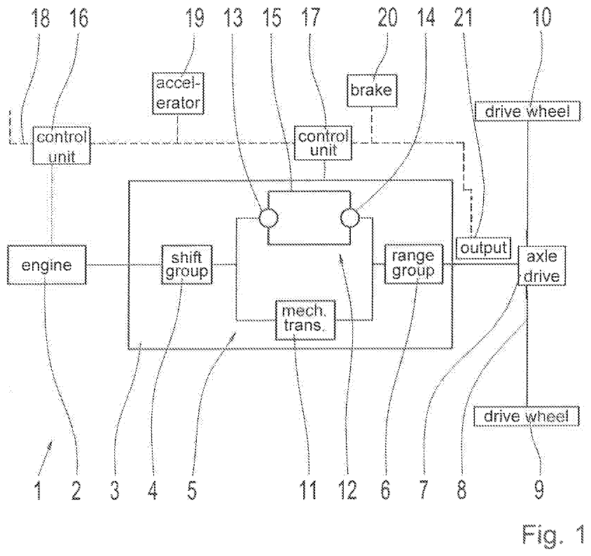

FIG. 1 shows a schematic view of a drive train 1 of a motor vehicle, which is in particular a commercial vehicle in the form of a mobile work machine such as a wheel loader. The drive train 1 comprises a main engine 2, which in the present case is designed as an internal combustion engine and connected on an output side to a motor vehicle transmission 3. The motor vehicle transmission 3 is composed of a shift group 4, a main group 5, and a range group 6, wherein the shift group 4 is arranged upstream of the main group 5 and the range group 6 is arranged downstream of the main group 5. Specifically, the shift group 4 is coupled to the output side of the main engine 2 and comprises two (not shown here) directional clutches, the selective actuation of which enables either forward or reverse travel of the motor vehicle.

On the output side, the motor vehicle transmission 3 is connected to an axle drive 7 of a drive axle 8 of the motor vehicle, wherein drive movement of the main engine 2 transmitted by the motor vehicle transmission is distributed to two drive wheels 9 and 10 of the drive axle 8.

As indicated in FIG. 1 in the present case the main group 5 of the motor vehicle transmission 3 is designed as a power-split transmission and is composed of a mechanical transmission 11 and a hydrostatic transmission 12. The mechanical transmission 11 (not illustrated in any further detail) is preferably embodied as a stepped transmission and can be a spur gear transmission or a planetary transmission.

The hydrostatic transmission 12 comprises two hydrostatic machines 13 and 14, which are interconnected in a hydraulic circuit 15 and which can each be operated either as a hydraulic pump or as a hydraulic motor. The two hydrostatic machines 13 and 14 are each swash plate machines, wherein a given delivery volume or displacement volume of the individual hydrostatic machine is defined by means of a currently set swivel angle of the hydrostatic machines 13 or 14, respectively. In the present case, the swivel angle can be varied in the hydrostatic machine 13 as well as in the hydrostatic machine 14 in order to after the delivery or displacement volumes, respectively.

A plurality of control units are assigned to the drive train 1, of which, in the present case, one is a control unit 16 of the main engine 2 and the other is a control unit 17 of the motor vehicle transmission 3. The control units 16 and 17 are integrated in a data bus system 18 of the motor vehicle, via which they obtain different information including, among other things, a current pedal position of an accelerator 19, the actuation state of a service brake 20 and a speed of an output 21 of the motor vehicle transmission 3.

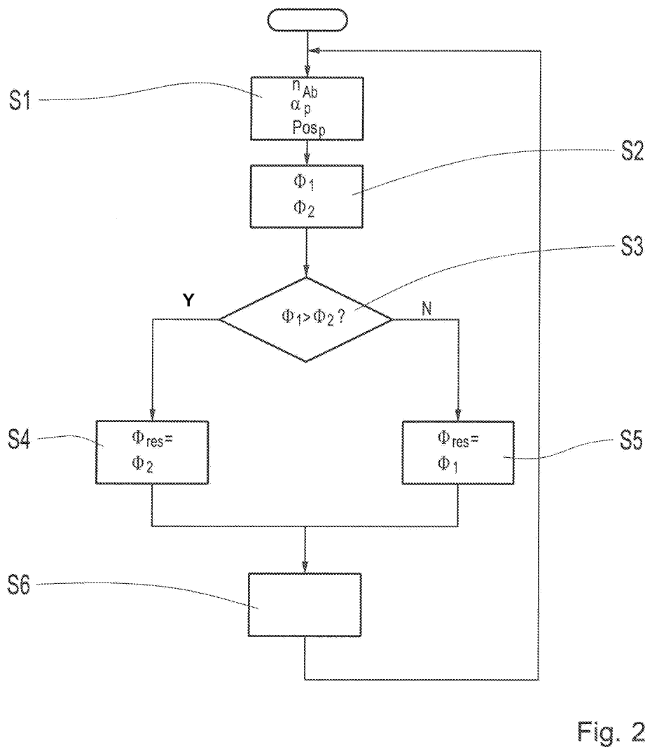

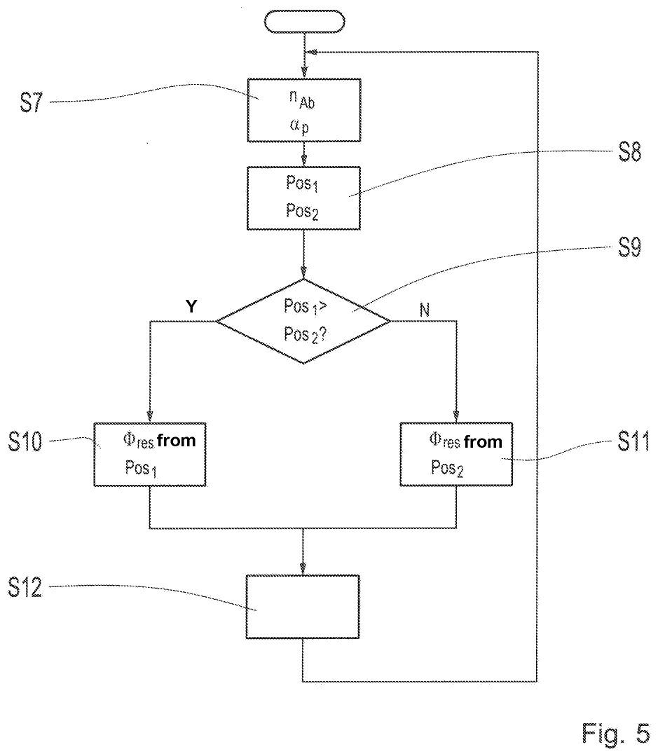

In the present case, a creep function of the motor vehicle can be realized by means of the hydrostatic transmission 12, this being achievable according to the flow diagram in FIG. 2 or according to the flow diagram from FIG. 5 as an alternative.

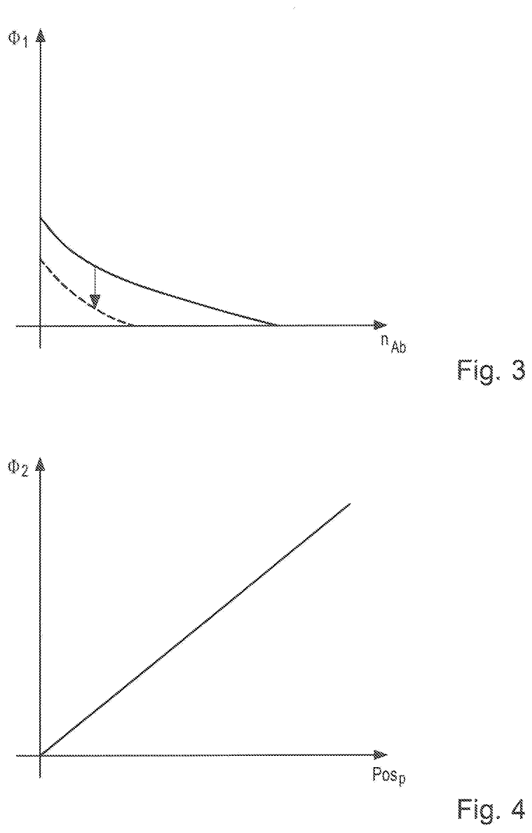

In this case, the flow diagram for operating the hydrostatic transmission 12 according to a first embodiment of the invention is presented in FIG. 2: first, in step S1, the current output speed n_{Ab}, of the motor vehicle transmission 3 and a current pedal angle α_{P}, of the accelerator 19 are read in, and a current pedal position Pos_{P} expressed as a percentage is determined from the latter. In a subsequent step S2, two nominal swivel angles Φ₁ and Φ₂ of the hydrostatic machine 13 of the hydrostatic transmission 12 are determined, of which the nominal swivel angle Φ₁ is a parameter that is dependent on a driving speed of the motor vehicle and thus also on the output speed n_{Ab} and the nominal swivel angle Φ₂ is a parameter that is dependent on the pedal position Pos_{P}. A determination of current values of the nominal swivel angles Φ₁ and Φ₂ is carried out specifically on the basis of the diagrams in FIG. 3 and FIG. 4.

In FIG. 3 the progression of the nominal swivel angle Φ₁ is plotted against the output speed n_{Ab} and in the diagram in FIG. 4 the nominal swivel angle Φ₂ is plotted against the pedal position Pos_{P} of the accelerator 19. In the diagram presented in FIG. 3, the actuation of the service brake 20 also has an effect on the nominal swivel angle Φ₁, wherein increasing actuation brings about a parallel shift of the progression of the nominal swivel angle Φ₁ towards smaller values, as indicated by the arrow and the dashed line in FIG. 3.

After determining the current values for the nominal swivel angles Φ₁ and Φ₂, these values are compared to one another in step S3, wherein a transition to a step S4 takes place for the case in which the current value of the nominal swivel angle Φ₁ is greater than the current value of the nominal swivel angle Φ₂, otherwise a switch to a step S5 takes place, In step S4, a value of a resulting swivel angle Φᵣₑₛ to be specified for the hydrostatic machine 13 is set equal to the current value of the nominal swivel angle Φ₁ and then in step S6, this nominal swivel angle is set in the hydrostatic machine 13 before going back to step S1. In contrast, in step S5 the value of the nominal swivel angle Φᵣₑₛ is set equal to the current value of the nominal swivel angle Φ₂, and then this is also set before going back to step S1.

The flow diagram of a method for operating the hydrostatic transmission 12 presented in FIG. 5 corresponds to a second design option of the invention. In this case, the current output speed n_{Ab} and a current pedal angle α_{P} of the accelerator 19 are read in, whereupon current values of a hypothetical accelerator position Pos₁ and of an actual accelerator position Pos₂ are determined therefrom in a step S8. The hypothetical accelerator position Pos₁ is thus a parameter that is dependent on a driving speed of the motor vehicle and therefore also on the output speed N_{Ab}, whereas the actual accelerator position Pos₂ is dependent on the current pedal angle α_{P}.

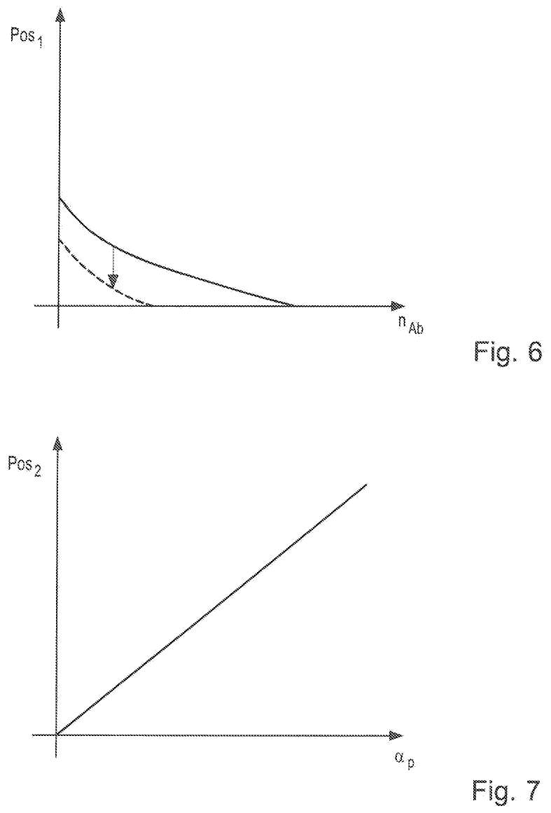

The determination of the current values of the hypothetical accelerator position Pos₁ and of the actual accelerator position Pos₂ takes place according to the diagrams presented in FIG. 6 and in FIG. 7, wherein FIG. 6 shows the progression of the hypothetical accelerator position Pos₁ plotted against the output speed n_{Ab}, whereas the progression of the actual accelerator position Pos₂ is plotted against the pedal angle α_{P} in FIG. 7. As can also be discerned in FIG. 6, the actuation of the service brake 20 has in addition an effect on the progression of the pedal position Pos₁, as in this case a parallel shift towards lower values occurs, as indicated by the arrow and the dashed line in FIG. 6.

In step S9, the two pedal positions Pos₁ and Pos₂ are compared to one another, wherein a transition to step S10 occurs if the hypothetical pedal position Pos₁ is greater than the actual pedal position Pos₂. A switch to step S11 occurs if the reverse is true.

In step S10, a current value of a resulting nominal swivel angle Φᵣₑₛ of the hydrostatic machine 13 is determined from the hypothetical accelerator position Pos₁, whereas in the case of step S11, the current value of the nominal swivel angle Φᵣₑₛ is determined from the actual pedal position Pos₂. Lastly, in a step S12 the respective value of the nominal swivel angle Φᵣₑₛ is specified as the swivel angle to be set in the hydrostatic machine 13 before going back to step S7.

With the method according to the invention, a creep function can be reproduced in a motor vehicle by means of a hydrostatic transmission.

### LIST OF REFERENCE SIGNS

1 Drive train
2 Main engine
3 Motor vehicle transmission
4 Shift group
5 Main group
6 Range group
7 Axle drive
8 Drive axle
9 Drive wheel
10 Drive wheel
11 Mechanical transmission
12 Hydrostatic transmission
13 Hydrostatic machine
14 Hydrostatic machine
15 Hydraulic circuit
16 Control unit
17 Control unit
18 Data bus system

### 19 Accelerator

20 Service brake

### 21 Output

n_{Ab} Current output speed
α_{P} Current pedal angle
Pos_{P} Current pedal position
Φ₁ Nominal swivel angle
Φ₂ Nominal swivel angle
Φᵣₑₛ Resulting nominal swivel angle
Pos₁ Hypothetical accelerator position
Pos₂ Actual accelerator position
S1 to S12 Individual steps

1-13. (canceled)

14. A method for operating a hydrostatic transmission (12) of a drive train (1) of a motor vehicle in which an automatic creep function of the motor vehicle is made possible by the hydrostatic transmission (12), the method comprising:
comparing a current value of a first parameter and a current value of a second parameter to one another, with the first parameter being independent of a pedal position of an accelerator (19) and the second parameter being dependent on a pedal position of an accelerator (19);
activating the creep function if the current value of the first parameter is greater than a current value of the second parameter;
determining, from the current value of the first parameter, a current value of a target delivery quantity of a hydraulic machine (13) of the transmission (12) operating as a pump in a context of the creep function;
taking into account a nominal swivel angle (Φ₁) of the hydrostatic machine (13) that is independent of the pedal position of the accelerator (19) as the first parameter, and taking into account a nominal swivel angle (Φ₂) of the hydrostatic machine (13) that is dependent on the pedal position as the second parameter; and
setting a value of a resulting nominal swivel angle (Φᵣₑₛ) of the hydrostatic machine (13) equal to the larger current value of the first and the second parameters in the context of the creep function.

15. The method according to claim 14, further comprising basing the first parameter on a driving speed of the motor vehicle.

16. The method according to claim 15, wherein a progression of the first parameter is degressive with respect to the driving speed.

17. The method according to claim 15, further comprising taking into account the driving speed with a sign attributed thereto, such that different progressions of the first parameter are specified for positive and for negative values of the driving speed.

18. The method according to claim 14, further comprising altering a progression of the first parameter by a driver of the vehicle.

19. The method according to claim 14, further comprising taken into account an actuation state of a service brake (20) of the motor vehicle, and a progression of the first parameter is altered when the service brake (20) is actuated.

20. The method according to claim 19, further comprising setting, above a defined actuation level of the service brake (20) the current value of the first parameter to zero.

21. A method of operating a hydrostatic transmission (12) of a drive train (1) of a motor vehicle in which an automatic creep function of the motor vehicle is made possible by the hydrostatic transmission (12), the method comprising:
comparing a current value of a first parameter and a current value of a second parameter to one another, and the first parameter being independent of a pedal position of an accelerator (19) and the second parameter being dependent on a pedal position of an accelerator (19);
activating the creep function as long as the current value of the first parameter is greater than the current value of the second parameter;
determining, as a function of the current value of the first parameter, a current value of a target delivery quantity of a hydraulic machine (13) of the transmission (12) operating as a pump in a context of the creep function;
taking into account a hypothetical pedal position (Pos₁) of the accelerator (19) as the first parameter, and taking into account an actual pedal position (Pos₂) of the accelerator (19) as a second parameter; and
determining, from the larger current value of the first and the second parameters, a current value of a nominal swivel angle (Φᵣₑₛ) of the hydrostatic machine (13) in the context of the creep function.

22. The method according to claim 21, further comprising basing the first parameter on a driving speed of the motor vehicle.

23. The method according to claim 22, wherein a progression of the first parameter is degressive with respect to the driving speed.

24. A control unit (17), for a hydrostatic transmission (12), comprising a device for regulating a delivery volume of a hydrostatic machine (13) of the transmission (12) operated as a pump, and the device being configured for comparing a current value of a first parameter and a value of a second parameter to one another, and the first parameter being independent of a pedal position of an accelerator (19) and the second parameter being dependent on a pedal position of the accelerator (19), and using the larger of the first and the second current values for determining a current value of a target delivery quantity of the hydrostatic ma⁻chine (13), and a nominal swivel angle (Φ₁) of the hydrostatic machine (13) that is independent of the pedal position of the accelerator (19) being taken into account as the first parameter and a nominal swivel angle (Φ₂) of the hydrostatic machine (13) that is dependent on the pedal position of the accelerator (19) being taken into account as the second parameter, and a value of a resulting nominal swivel angle (Φᵣₑₛ) of the hydrostatic machine (13) being set equal to the larger current value of the first and the second parameters in a context of the creep function.

25. A control unit (17) for a hydrostatic transmission (12), comprising a device for regulating a delivery volume of a hydrostatic machine (13) of the transmission (12) operated as a pump, the device being configured for comparing a current value of a first parameter and a value of a second parameter to each other, the first parameter being independent of a pedal position of an accelerator (19) and the second parameter being dependent on a pedal position of the accelerator (19), and for using the larger of the first and the second current values for determining a current value of a target delivery quantity of the hydrostatic machine (13), and a hypothetical pedal position (Pos₁) of the accelerator (19) being taken into account as the first parameter and an actual position (Pos₂) of the accelerator (19) being taken into account as the second parameter, the larger current value of the first and the second parameters being used in a context of the creep function for determining a current value of a nominal swivel angle (Φᵣₑₛ) of the hydrostatic machine (13).

26. A computer program product for a control unit (17) according to claim 24, the computer program product being configured to implement a routine for comparing the current values of the first and the second parameters and for determining the current value of the target delivery quantity by suitable control commands stored in a software program for carrying out a method of operating the hydrostatic transmission (12) of the drive train (1) of the motor vehicle in which the automatic creep function of the motor vehicle is made possible by the hydrostatic transmission (12), the method including: comparing the current value of the first parameter and the current value of the second parameter to one another, the first parameter being independent of the pedal position of the accelerator (19) and the second parameter being dependent on the pedal position of the accelerator (19); activating the creep function if the current value of the first parameter is greater than the current value of the second parameter; determining from the current value of the first parameter, the current value of the target delivery quantity of the hydraulic machine (13) of the transmission (12) operating as the pump in the context of the creep function; taking into account the nominal swivel angle (Φ₁) of the hydrostatic machine (13) that is independent of the pedal position of the accelerator (19) as the first parameter, and taking into account the nominal swivel angle (Φ₂) of the hydrostatic machine (13) that is dependent on the pedal position as the second parameter; and setting the value of the resulting nominal swivel angle (Φᵣₑₛ) of the hydrostatic machine (13) equal to the larger current value of the first and the second parameters in the context of the creep function.
